(19) United States
(12) Patent Application Publication
(10) Pub. No.: US 2017/0025991 A1
(43) Pub. Date: Jan. 26, 2017

(54) PORTABLE PHOTOVOLTAIC DEVICE

(71) Applicant: FLEXWAVE CO., LTD., Zhubei City (TW)

(72) Inventors: Chun-Hsien CHOU, Taichung City (TW); Min-Hung HSU, Taipei City (TW); Meng-Syuan YANG, Chiayi City (TW); Cheng-Ming HUNG, New Taipei City (TW); Chia-Chi KAN, Taoyuan City (TW); Chia-Ting HSU, Hsinchu County (TW)

(21) Appl. No.: 14/807,535

(22) Filed: Jul. 23, 2015

(51) Int. Cl. H02S 40/22; H02S 40/38; H02S 10/40

(52) U.S. Cl. CPC H02S 40/22; H02S 10/40; H02S 40/38

(57) ABSTRACT

A portable photovoltaic device includes a waveguide body, a photovoltaic cell, an electronic module, and a fixing element. Waveguide material having transparency, flexibility, plasticity and weather resistance encapsulates photovoltaic cells and electronic module, without complicated light focusing system to converge light on a photovoltaic cell, to improve the power generating efficiency of the photovoltaic cell. Portable photovoltaic device of the present invention may be applied to wearable devices, mobile carrier or portable fixed electronic device, which has advantages of light weight, convenient use, energy saving, protection of electronics and environment friendly.

### BACKGROUND OF THE INVENTION

1. Field of the Invention

The present invention relates to a photovoltaic device, and particularly to a portable photovoltaic device.

2. Description of the Prior Art

Wearable or portable fixed electronic devices have become an overwhelming trend in the world. Traditional wearable electronic devices, such as a smart wristwatch, generally use disposable batteries or rechargeable batteries to provide power required by the electronic devices during operation. However, the disposable batteries are not environment friendly and the charging outlets for the rechargeable batteries can not be found at anytime and anywhere. Thus, a photovoltaic cell that is a promising environment friendly power-generating technology. To comply with a requirement of the flexibility of the wearable electronic devices, current thin film photovoltaic cells having the characteristic of flexibility, such as amorphous silicon photovoltaic cells, organic photovoltaic cells . . . etc., still can not be actually applied to commercial products due to the limited bending ability of the electrode materials, a short life cycle and toxic fabrications involving poisonous solvents. However, traditional photovoltaic cells, such as silicon photovoltaic cells, photovoltaic cells of groups III-V, etc. which are commercially available, generally require complex light-focusing systems or larger areas of photovoltaic panels to enhance the solar electricity. Moreover, the rigidity of traditional photovoltaic cells cannot fulfill the requirement of the flexibility or plasticity. Thus, a lot of technical problems have to be overcome for traditional photovoltaic cells so as to be applied to wearable or portable fixed electronic devices.

To sum up the foregoing descriptions, how to provide an environment friendly powered and flexible portable photovoltaic device is the most important goal for now.

### SUMMARY OF THE INVENTION

The present invention is directed to provide a portable photovoltaic device, which utilizes a waveguide body that integratedly encapsulates a photovoltaic cell and an electronic module to enhance the power-generating efficiency of the photovoltaic cell, protect the electronic module, support the electricity needed of the electronic module, and have advantages of light weight, convenient use, energy saving and environment friendly.

A portable photovoltaic device of one embodiment of the present invention comprises a waveguide body, a photovoltaic cell, an electronic module and a fixing element. The waveguide body has an incident face and a surface opposite the incident face, wherein external light passes the incident face into the waveguide body. The photovoltaic cell is encapsulated in the waveguide body for receiving light in the waveguide body irradiated to the photovoltaic cell. The electronic module is connected to the waveguide body and the electronic module is electrically connected to the photovoltaic cell for receiving electricity generated by the photovoltaic cell. The fixing element is connected to the waveguide body for the waveguide body detachably fixed to a body or an object.

The objectives, subject matters and properties of the present invention and the effects achieved by the present invention will become apparent from the following descriptions of the embodiments taken in conjunction with the accompanying drawings.

### BRIEF DESCRIPTION OF THE DRAWINGS

FIG. 1 is a schematic view showing a portable photovoltaic device of one embodiment of the present invention.

FIG. 2 is a schematic view showing a portable photovoltaic device of one embodiment of the present invention.

FIG. 3 is a schematic view showing a portable photovoltaic device of another embodiment of the present invention.

FIG. 4 is a schematic view showing a portable photovoltaic device of yet another embodiment of the present invention.

FIG. 5 is a curve diagram showing a flexibility test diagram of the portable photovoltaic device of one embodiment of the present invention.

### DESCRIPTION OF THE PREFERRED EMBODIMENT

Various embodiments of the present invention will be described in detail below and illustrated in conjunction with the accompanying drawings. In addition to these detailed descriptions, the present invention can be widely implemented in other embodiments, and apparent alternations, modifications and equivalent changes of any mentioned embodiments are all included within the scope of the present invention and based on the scope of the Claims. In the descriptions of the specification, in order to make readers have a more complete understanding about the present invention, many specific details are provided; however, the present invention may be implemented without parts or all of the specific details. In addition, the well-known steps or elements are not described in detail, in order to avoid unnecessary limitations to the present invention. Same or similar elements in Figures will be indicated by same or similar reference numbers. It is noted that the Figures are schematic and may not represent the actual size or number of the elements. For clearness of the Figures, some details may not be fully depicted.

The present invention provides a portable photovoltaic device, which utilizes a waveguide body having high transparency, high flexibility, and plasticity to fabricate a photovoltaic device which can guide external light to generate solar electricity. Also, the portable photovoltaic device is suitable for an integrated encapsulating process that encapsulates a photovoltaic cell and various electronic modules simultaneously to provide protection of weather resistance, so that the portable photovoltaic device is applicable for various wearable devices or installation locations.

The waveguide material of the waveguide body comprises at least one of a thermoplastic elastomer (TPE) and a photocureable polymer (PCP). Wherein, the thermoplastic elastomer is a material that is high resilient, environment friendly, non-toxic and safe, and which texture is softer and more resilient than the plastic particles. The production process for the thermoplastic elastomer is a low temperature process, and the thermoplastic elastomer has characteristics of excellent tinting ability and weather resistance. For example, the thermoplastic elastomer of the waveguide material comprises at least one of thermoplastic rubber (TPR), thermoplastic vulcanizate (TPV), thermoplastic polyurethane (TPP) and thermoplastic polyether ester elastomer (TPEE). On the other hand, the photocureable polymer comprises polydimethylsiloxane (PDMS), which is also a material of the thermoplastic rubber (TPR). In summary, the commonly used flexible waveguide materials and the category thereof are listed in table 1, but are not limited to this.

TABLE 1

| Name (abbreviation) | category |
|---|---|
| styrene-ethylene/butylene-styrene (SEBS) | TPR |
| Polydimethylsiloxane (PDMS) | TPR/PCP |
| Polyvinyl Alcohol (PVA) | TPV |
| Polyvinyl Pyrrolidone (PVP) | TPV |
| Cycloolefin copolymer (COC) | TPV |
| Polyurethane (PU) | TPP |
| Styrene methyl metacrylate (SMMA) | TPEE |

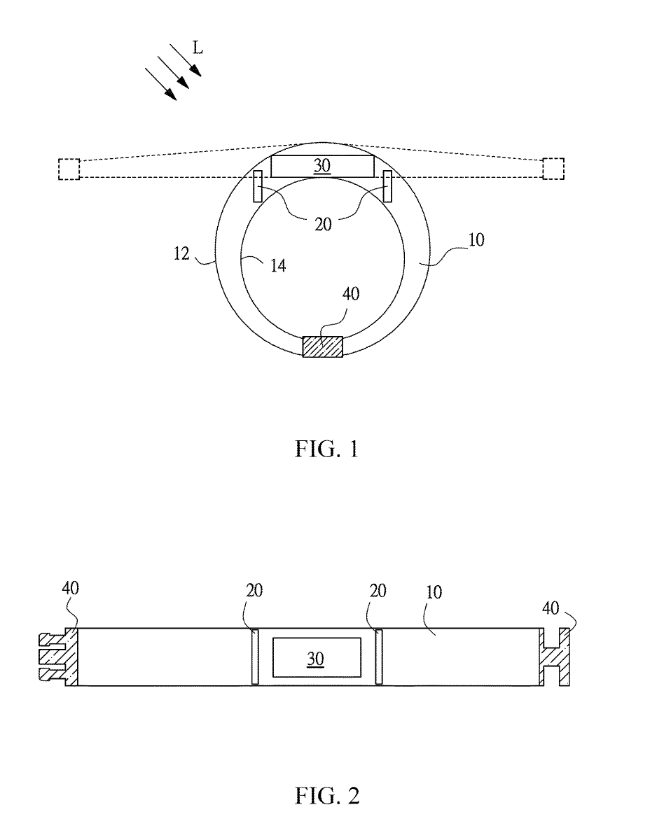

Referring to FIGS. 1 and 2 together, the portable photovoltaic device of one embodiment of the present invention may be applied to a wearable electronic device, and comprises a waveguide body 10, a photovoltaic cell 20, an electronic module 30 and a fixing element 40. In this embodiment, the waveguide body 10 comprises a flexible strip structure, both ends of which are connected to the fixing element 40 and which may be bended into a C shape or various possible shapes. The fixing element 40 may be a buckle so that the waveguide body 10 is wearable by a user. It may be understood that the fixing element 40 may also be a tenon, and modifications and/or alternations may be made by those skilled in the art, which may not be a limitation. In some embodiments, the electronic module 30 comprises a digital watch, a physiological information sensor, a wireless sensor, a pedometer, an electronic paper, a global positioning system (GPS), or a power management integrated circuit. Wherein, the physiological sensor is used to sense the physiological information including, but not limited to, the pulse, heart rate, breathing or body temperature of a user. The wireless sensor may be a temperature sensor, a humidity sensor, a gravity sensor, a smoke sensor, an infrared sensor or an RF tag sensor, etc. The power management integrated circuit may function as a transformer or a booster. Those skilled in the art may utilize various electronic modules or an integrated modules thereof as needed. It can be understood that the electronic module 30 may transmit the obtained physiological information or other sensed data to an external electronic device or a cloud device through a wireless communication unit, such as a low power consumption Bluetooth communication unit, WiFi, etc., which is omitted herein. Preferably, the portable photovoltaic device may carry a rechargeable battery incorporated with the photovoltaic cell, based on the required power of various electronic modules during operation, but the above embodiment is not a limitation.

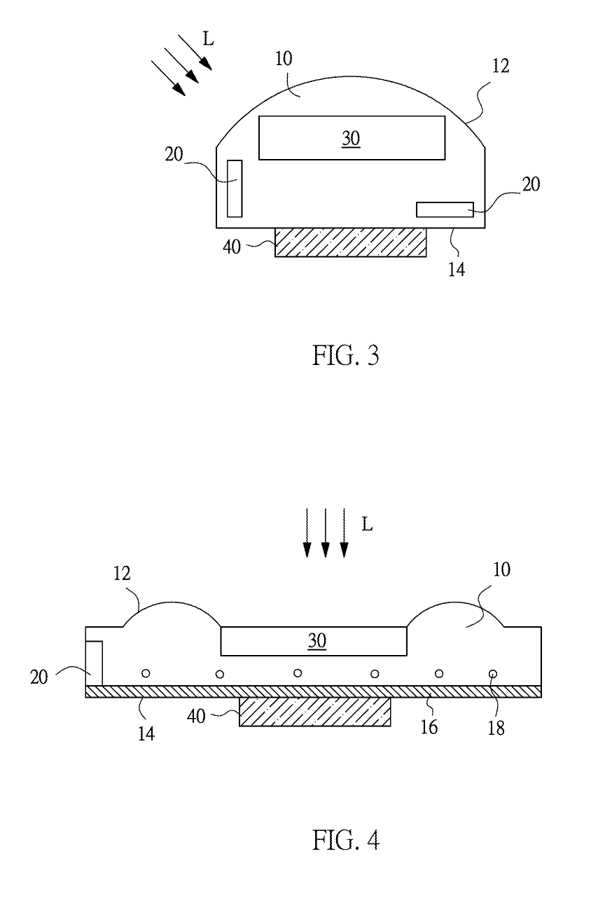

Referring to FIG. 3, it is needed to be explained that a portable photovoltaic device of another embodiment of the present invention may be applied to a portable fixed electronic device. The waveguide body 10 of the portable photovoltaic device is detachably fixed to an object through a fixing element 40, such as a fixer, a magnetically attached element or a buckle. The object may be a mobile carrier, such as a bicycle, a motorcycle, a car, or a transporting vehicle, and the object may also be a wall, a ceiling, etc. For example, when a user rides a bicycle, the user may wear a smart wristwatch of one embodiment as shown in FIG. 1 which has physiological information monitoring function and timing function. In addition, the portion of the dotted line in FIG. 1 shows the initial shape of the waveguide body 10 before bended for wear. The user may also utilize the portable fixed electronic device of one embodiment as shown in FIG. 3 which has an electronic paper display screen and the global positioning system to provide a reference riding route to the user and estimate the riding distance thereof, and after the utilization of the portable fixed electronic device, the user may detach the portable fixed electronic device from the bicycle. Moreover, for monitoring the temperature or humidity of an environment, the portable fixed electronic device of another embodiment as shown in FIG. 3 which has a temperature sensor or a humidity sensor could be detachably fixed to a wall of an observatory.

Continued with the above descriptions, the waveguide body 10 has an incident face 12 and a surface 14 opposite the incident face 12. In some embodiments, the waveguide body 10 comprises a polyhedron, a tetrahedron, a cylinder, a semi spheroid or a combination thereof. In one embodiment in FIG. 3, the waveguide body 10 comprises a semi spheroid, and the incident face 12 thereof has a semi sphere surface, such that the waveguide body 10 may gather more external light L. In one embodiment in FIG. 4, the incident face 12 comprises multiple semi sphere surfaces arranged in a matrix, so as to gather more external light L from different irradiation angles. Suitable modifications and/or alternations may be made by those skilled in the art, and a shape of the waveguide body 10 is not limited by the present invention.

The photovoltaic cell 20 is encapsulated in the waveguide body 10. Moreover, the external light L is incident into the waveguide body 10 through the incident face 12 and irradiates onto the photovoltaic cell 20. The electronic module 30 is electrically connected to the photovoltaic cell 20 to receive electricity generated by the photovoltaic cell 20. It can be understood that if the electronic module 30 is not encapsulated in the waveguide body 10 along with the photovoltaic cell 20 simultaneously, the electronic module 30 may be embedded on the waveguide body 10 and electrically connected to the electrodes of the photovoltaic cell after the waveguide body 10 has formed.

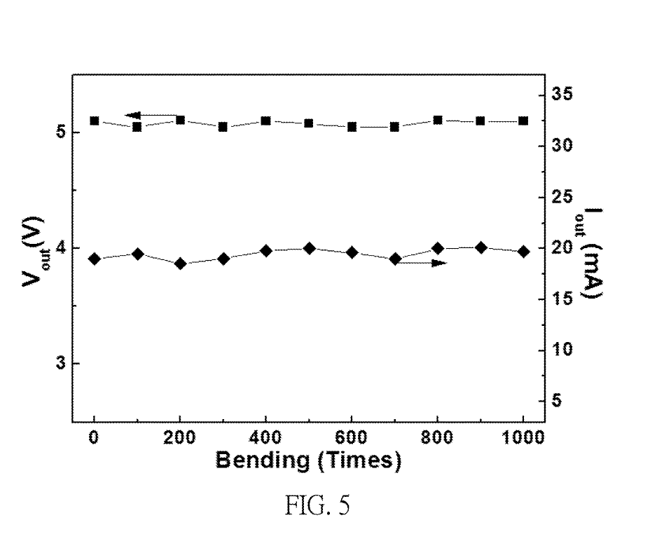

It is needed to be explained particularly that the portable photovoltaic device of the present invention has high flexibility, and the power-generating efficiency thereof is not deteriorated after multiple bending tests. In one embodiment, two pieces of polycrystalline silicon photovoltaic cells of 2.2×0.5 cm² in series are encapsulated with polydimethylsiloxane (PDMS), and after cured, a layer of silica gel doped with titanium dioxide (TiO₂) is coated as a reflective layer on the surface of the waveguide body opposed to the incident face. As a result, a waveguide wristwatch strip encapsulating a photovoltaic cell is completed. Then, the positive pole and negative pole of the photovoltaic cell are electrically connected to a booster module to output power having a voltage of 5.14 V and a current of 20 mA as the power required by a smart wristwatch during operation or charging. Finally, referring to FIG. 5, a fairly stable power output curve diagram is obtained after the waveguide body of the portable photovoltaic device of the present embodiment experienced 1000 bending tests while the relative power output performance thereof is recorded simultaneously. It is learned that, compared with the traditional photovoltaic cell technology, the portable photovoltaic device of the present invention may improve the light absorption of the photovoltaic cell and output stable power with the waveguide body without complicated light-focusing elements, and may be bended repeatedly for wear.

To improve the efficiency of the waveguide body for capturing light, the waveguide body further comprises a scattering structure. Referring to FIG. 4 again, a scattering structure 16 is disposed at the surface side of the waveguide body 10 to scatter the external light L incident into the waveguide body 10. Through this specification, the surface side is referred to the inner side in the waveguide body 10 and near the surface 14. In one embodiment, the scattering structure 16 comprises a scattering powder, which is doped into the surface side of the waveguide body 10 or coated on the surface 14 of the waveguide body 10 to enhance the light irradiated to the photovoltaic cell 20. In another embodiment, the scattering structure 16 comprises a microstructure, which is disposed at the surface 14 of the waveguide body 10 to enhance the light irradiated to the photovoltaic cell 20. For example, the microstructure 14 may be a pyramidal microstructure, a semi sphere microstructure, a rectangular microstructure, a roughed microstructure or a combination thereof.

To improve the power efficiency and the color diversification of the photovoltaic cell, the waveguide body further comprises a luminescent dye or a quantum dot, which has the optical characteristic to red-shift the wavelength of the incident light, so as to transform a first light of the external light L into a second light, wherein a wavelength of the second light is longer than that of the first light. For example, referring to FIG. 4 again, a luminescent dye 18 is doped into the waveguide body 10. The luminescent dye absorbs the ultraviolet light (in a wavelength range from 300 to 400 nm) and transforms it into the blue light (in a wavelength range from 400 to 500 nm) to comply with the working wavelength range required by the photovoltaic cell.

To improve the power efficiency of the photovoltaic cell, in one embodiment, the portable photovoltaic device further comprises a reflective layer (not shown) disposed at the surface 14, such as a mirror surface patch or a coating layer doped with titanium dioxide, to reflect the light in the waveguide body 10 irradiated to the surface 14, so as to enhance the light irradiated to the photovoltaic cell 20.

To enhance the contaminant resistance of the portable photovoltaic device, in one embodiment, an outer portion of the portable photovoltaic device may have a protective layer (not shown) disposed on the incident face or the surface of the waveguide body. Furthermore, the protective layer may be a contaminant resistive and transparent plastic material that has a lower refractive index than the waveguide body, including at least one of ethylene-tetra-fluoro-ethylene (ETFE), ethylene-chlorotrifluororthylene (ECTFE), polytetrafluoroethylene (PTFE), fluorinated ethylene propylene (FEP), polyethylene terephthalate (PET) and polycarbonate (PC).

To sum up the foregoing descriptions, a portable photovoltaic device of the present invention utilizes a waveguide body that integratedly encapsulates a photovoltaic cell and an electronic module to enhance the power-generating efficiency of the photovoltaic cell and has advantages of light weight, convenient use, energy saving and environmentally friendly. Also, the portable photovoltaic device adopts the integrated encapsulating process to simplify the production process, and the weather resistance of the waveguide body may be utilized to protect the electronic module from the influence of outer contaminant or weather, so as to extend the use life and the reliability of the electronic module. Compared with the traditional photovoltaic cell technology, the portable photovoltaic device of the present invention may improve the light absorption of the photovoltaic cell and output stable power with the waveguide body without complicated light-focusing elements, and may be bended repeatedly for wear.

What is claimed is:

1. A portable photovoltaic device, comprising:
a waveguide body, having an incident face and a surface opposite the incident face, wherein external light passes the incident face into the waveguide body;
a photovoltaic cell, encapsulated in the waveguide body, for receiving light in the waveguide body irradiated to the photovoltaic cell;
an electronic module, connected to the waveguide body and electrically connected to the photovoltaic cell, for receiving electricity generated by the photovoltaic cell; and
a fixing element, connected to the waveguide body, for the waveguide body detachably fixed to a body or an object.

2. The portable photovoltaic device according to claim 1, wherein the electronic module comprises a power management integrated circuit, a wireless sensor, a digital watch, a physiological information sensor, a pedometer, an electronic paper, or a global positioning system.

3. The portable photovoltaic device according to claim 1, wherein the fixing element comprises a fixer, a magnetically attached element or a buckle, for the waveguide body detachably fixed to an object, which comprises a mobile carrier, a wall or a ceiling.

4. The portable photovoltaic device according to claim 1, wherein the waveguide body comprises a flexible strip structure, and the fixing element comprises a buckle or a tenon, connected to both ends of the flexible strip structure, for the waveguide body to form a wearable shape and detachably fixed to a user.

5. The portable photovoltaic device according to claim 1, wherein the waveguide body comprises a polyhedron, a tetrahedron, a cylinder, a semi spheroid or a combination thereof.

6. The portable photovoltaic device according to claim 1, wherein the waveguide body is flexible and comprising at least one of a thermoplastic elastomer (TPE) and a photocureable polymer (PCP).

7. The portable photovoltaic device according to claim 1, wherein the waveguide body is flexible and comprising at least one of polyurethane (PU), cycloolefin copolymer (COC), styrene methyl metacrylate (SMMA), styrene-ethylene/butylene-styrene (SEBS), polyvinyl alcohol (PVA), polyvinyl pyrrolidone (PVP), and polydimethylsiloxane (PDMS).

8. The portable photovoltaic device according to claim 1, wherein the waveguide body further comprises a luminescent dye or a quantum dot, doped into the waveguide body.

9. The portable photovoltaic device according to claim 1, wherein the waveguide body further comprises a scattering structure, disposed at the surface side of the waveguide body to scatter the external light incident into the waveguide body.

10. The portable photovoltaic device according to claim 9, wherein the scattering structure comprises a scattering powder, doped into the surface side of the waveguide body or coated on the surface of the waveguide body.

11. The portable photovoltaic device according to claim 9, wherein the scattering structure comprises a microstructure, disposed at the surface of the waveguide body, and the microstructure comprises a pyramidal microstructure, a semi sphere microstructure, a rectangular microstructure, a roughed microstructure or a combination thereof.

12. The portable photovoltaic device according to claim 1, further comprising a reflective layer.

13. The portable photovoltaic device according to claim 1, further comprising:
a protective layer disposed at the incident face or the surface of the waveguide body, wherein the protective layer comprises at least one of ethylene-tetra-fluoro-ethylene (ETFE), ethylene-chlorotrifluororthylene (ECTFE), polytetrafluoroethylene (PTFE), fluorinated ethylene propylene (FEP), polyethylene terephthalate (PET) and polycarbonate (PC).

14. The portable photovoltaic device according to claim 1, further comprising a rechargeable battery electrically connected to the photovoltaic cell.
